(19) United States
(12) Patent Application Publication
(10) Pub. No.: US 2004/0159016 A1
(43) Pub. Date: Aug. 19, 2004

(54) Method for manufacturing a part of a sports boot

(76) Inventor: Ricardo Perotto, Via Generale Vaccari (IT)

Correspondence Address: BUGNION S.A., CASE POSTALE 375, ROUTE DE FLORISSANT 10, GENEVA 12, CH-1211, CH

(21) Appl. No.: 10/705,767

(22) Filed: Nov. 10, 2003

(30) Foreign Application Priority Data
Nov. 13, 2002 (FR) 02 14153

(51) Int. Cl. A43B 23/02; B29C 44/12; B29D 31/518

(52) U.S. Cl. 36/45; 264/46.5; 264/236; 264/257; 264/258; 264/132; 12/146 C

(57) ABSTRACT

The method for manufacturing a part of a sports boot is one which essentially comprises the following steps:

preparing a first blank in a first flexible material intended to form the external face of the boot part, and a second blank in a second flexible material intended to form the internal face of the boot part,

placing the first and second blanks on the impression of a first half of a mold, with the first blank against the impression,

closing the mold by using its second half,

injecting a foamable binding material between the blanks,

mold release after polymerization of the injected material so as to obtain the boot part.

Such a production method makes it easier to add decorative patterns and to add auxiliary elements on the upper of the boot.

### BACKGROUND OF THE INVENTION

The present invention relates to a method for manufacturing a part of a sports boot in composite material from flat elements. It furthermore relates to a boot upper produced by such a method.

### PRIOR ART

In the field of sports boots, and especially in the field of ski boots, it is well known to produce boots by injecting plastic material into a mold so as to obtain a shell whose internal shape is defined and reproducible by molding. All the methods have the major drawback that the shell of the boot cannot be provided with flaps which overlap so as to provide relatively leaktight closure of the boot, on the top of the boot and level with the lower leg.

Patent FR 1 547 769, the content of which is incorporated by reference, discloses a method which overcomes this drawback. This method consists in producing a ski boot by the leaktight assembling of two elements, which are obtained separately by molding. Each element can thus be provided with shapes that locally extend beyond the plane in which it is joined to the other element. These elements may be made of rubber or synthetic material.

Furthermore, U.S. Pat. No. 6,558,784, the content of which is incorporated by reference, discloses a method for producing a skating boot upper from a plurality of elements in composite material, which are assembled together. A first stage of this method consists in producing flat elements comprising at least two layers of different materials. Each flat element is subsequently heated then compressed between two dies, in order to provide it with its permanent shape. These elements are finally assembled together.

These methods also make it possible to obtain a reproducible internal shape, but they nevertheless have a drawback. After the various elements have been produced, it is still necessary to attach auxiliary elements to them, such as eyelets for the laces intended for closing and tightening the boot. These operations are made difficult by the fact that the boot elements have already been provided with their final three-dimensional shape. Furthermore, in the case of the method mentioned last, the heating phase means that the auxiliary elements cannot be attached before the shaping and thermoforming modifies the surface condition of the material forming the outside of the boot, which usually prevents the desired surface condition from being obtained.

Patent FR 1 426 842, the content of which is incorporated by reference, also discloses a method for manufacturing soles of sandals.

### SUMMARY OF THE INVENTION

It is an object of the invention to provide a method for producing boot elements, which offers a solution to the aforementioned problem and improves the methods of the prior art. In particular, the invention provides a method for producing a boot which makes it easier to add decorative patterns and to add auxiliary elements on these elements of the boot.

The manufacturing method according to the invention is specified in claim 1.

Various embodiments of the method are defined by dependent claims 2 to 20.

Claim 21 defines a sports boot upper which is obtained by the aforementioned method.

### BRIEF DESCRIPTION OF THE DRAWINGS

An exemplary embodiment of the method according to the invention will be described with reference to the appended drawing, in which:

FIG. 1 is a perspective view of a boot, the upper of which has been produced according to the invention.

FIG. 2 is a rear view of a boot, the upper of which has been produced according to the invention.

FIG. 3 is a front view of a flat blank in flexible material, intended to constitute the external surface of a part of a boot.

FIG. 4 is a front view of a flat blank in flexible material, intended to constitute the internal surface of a part of a boot.

FIG. 5 is a perspective view of a part which has been produced according to the invention and is intended to be assembled with a similar and symmetrical part in order to form a boot upper.

FIG. 6 is a view from above of two halves of a mold for producing the part represented in FIG. 5.

### DESCRIPTION OF THE PREFERRED EMBODIMENT

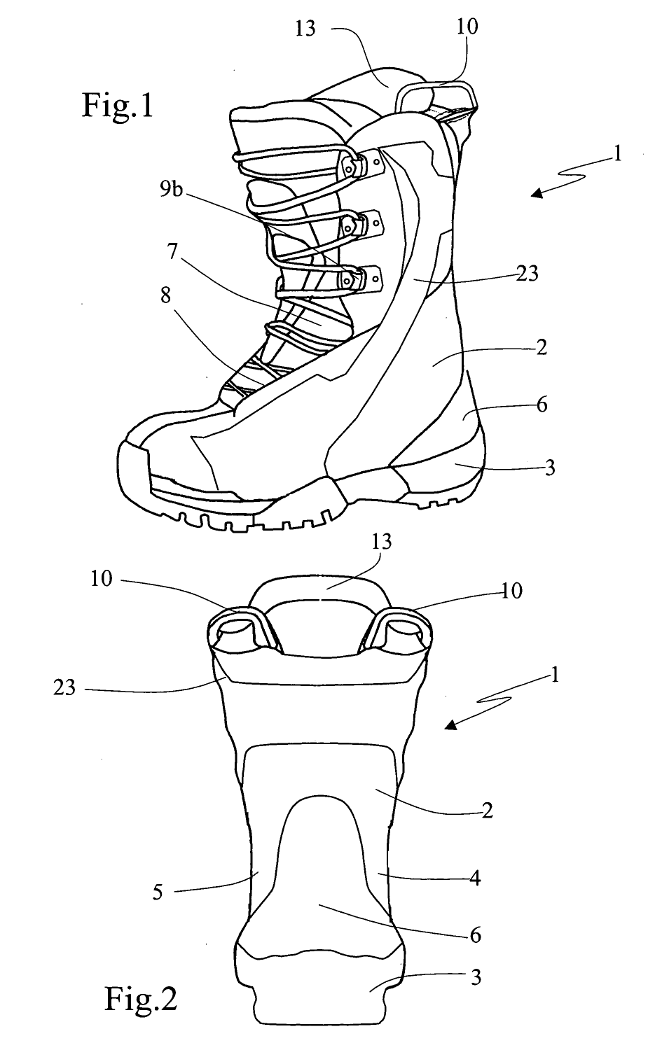

The boot 1 represented in FIGS. 1 and 2 is intended for snowboarding. It consists principally of a semirigid upper 2 and a sole 3. The upper 2 is essentially produced from two half-shells 4, 5 assembled by stitching and/or adhesive bonding in a median plane, which divides the upper into a part 4 covering the outside of the user's foot and a part 5 covering the inside of the user's foot. The upper 2 furthermore comprises an affixed part 6 of substantially triangular shape, forming the heel of the boot 1. The sole 3, formed by an internal part and an external part which are secured together, is assembled before being fitted on the upper 2 of the boot by adhesive bonds and/or stitched seams. The boot 1 also has a tongue 7 secured to the upper at the bottom of its frontal opening 8. The boot is provided with an inner 13 for comfort.

The upper 2 of the boot comprises eyelets 9a for the laces, rings 10 for gripping, watertight flap 11 secured to the two shells 4, 5 level with the eyelets 9 for the laces, flaps 12 to prevent the fixing means of the tightening loops from affecting the inner 13, and decorations 23. The two half-shells are shaped after these various auxiliary elements have been fitted on the different elements intended to form the half-shells.

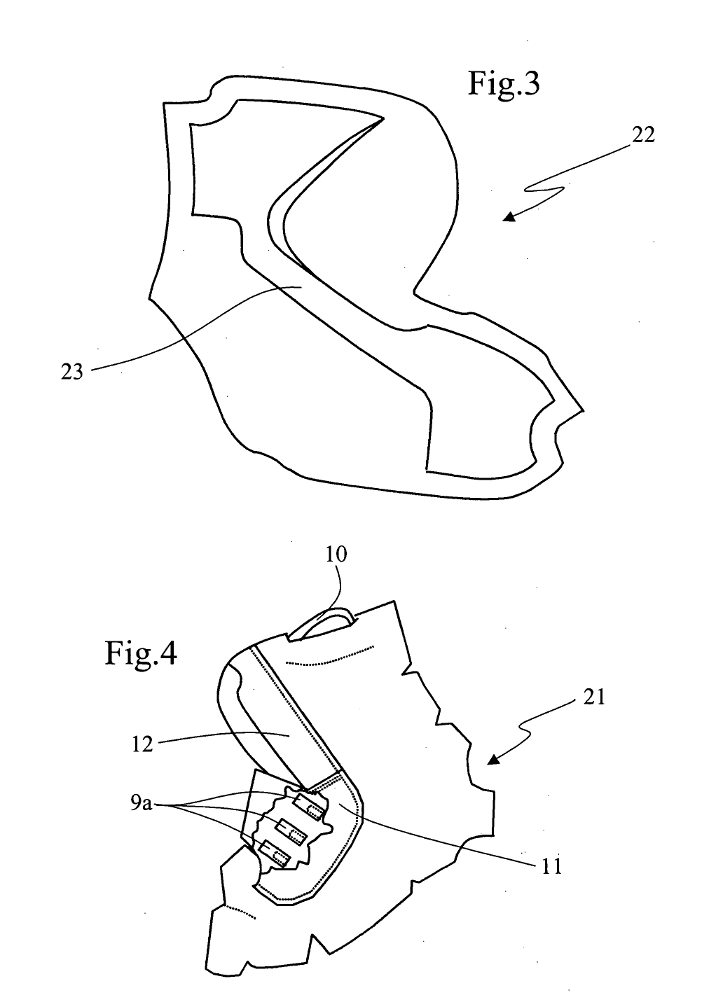

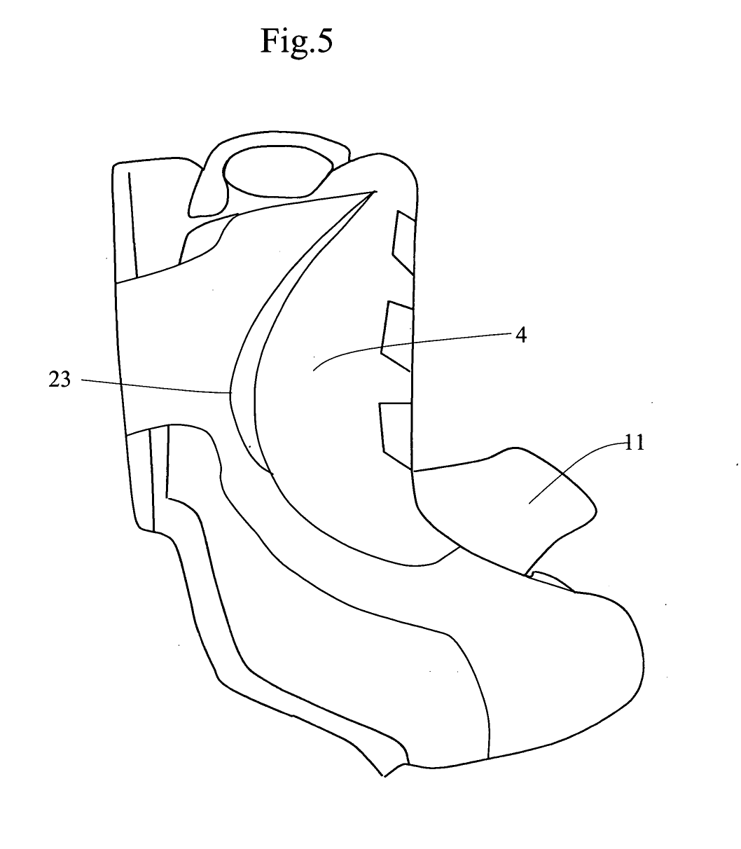

Hence, the production of a half-shell 4 as represented in FIG. 5 begins with cutting out two blanks made of flexible materials, referred to as the internal blank 21 and the external blank 22, which are represented in FIGS. 3 and 4 and are respectively intended to form the internal and external surfaces of the half-shell 4.

An ink is applied to the external blank 22 by a known screen printing method in order to produce decorative patterns 23, and elements such as brand names are printed in this way. This assembling is carried out flat, the blank not yet having its final shape.

A ring 10 for gripping is assembled onto the internal blank 21 by stitching, in a region intended to be located at the top of the high part of the upper 2 once the boot is finished. Eyelets 9a for laces, a watertight flap 11 secured level with the eyelets 9a and a flap 12 over the instep, level with the frontal opening of the upper, are assembled by stitching. All this assembling is carried out flat, the blank not yet having its final shape. The blank may also be preformed by stitching.

The flap 12 prevents a wear effect on the comfort inner 13 due to contact with the eyelet fixing rivets 9b made of a hard plastic material or metal, which cannot be stitched onto the upper.

Four blanks are thus prepared, two to form one of the half-shells of the upper and two others to form the other half-shell of the upper.

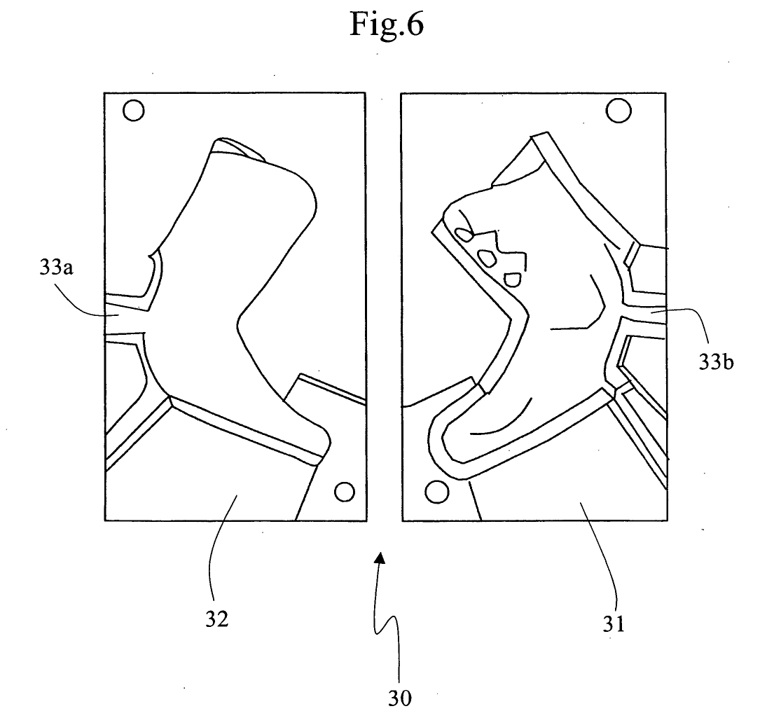

In order to produce one half-shell 4, the two blanks 21, 22 intended to form this half-shell are positioned, on top of one another, on the first half 31 of a mold 30 having the hollow impression of the half-shell of the upper. This mold is represented in FIG. 6. In order to position them, the blanks 21 and 22 have a plurality of holes in their borders, allowing them to be secured to pins fixed on the mold 30. The mold is then closed by using its second half 32, and a foamable binding material, such as a polyurethane foam with two components and a blowing agent, is injected between the blanks 21 and 22 through an orifice formed by the channels 33a and 33b, then release from the mold is carried out after polymerization of the foam. The half-shell 4 which is obtained is semirigid, and its external and internal surfaces are complete. In particular, the external surface has its decoration and its permanent appearance.

A half-shell is thus obtained which, after it has been trimmed, then merely needs to be assembled with another half-shell 5 obtained by the same method, and with other elements such as the sole 3 and the element 6 of the upper forming the heel, by known adhesive bonding, welding and/or stitching methods.

The half-shell 4 which is obtained after release from the mold has its final three-dimensional shape and is almost finished; it has in particular the advantage of being already provided with eyelets 9a for laces, a watertight flap 11 level with these laces, a flap 12 to protect the comfort inner, and decorations 23 on its external part.

A synthetic elastic fabric will preferably be used for the blank forming the external surface of the upper, for example a polyamide, polyester or Lycra (registered trademark), normally waterproofed by means of an SEL, PU or PVC elastomer with a thickness of the order of from 0.8 to 1 mm. The elastomer film also has the effect of anchoring the foamable binding material.

An elastic synthetic fabric, such as those mentioned for producing the external surface, may be used for the blank forming the internal surface of the upper. It is also possible to use a material comprising a polyester felt, the thickness of which is of the order of from 1 to 3 mm.

The materials mentioned in this embodiment are merely examples. In order to produce the blanks, it is in fact possible to use any flexible material compatible with the stitching and adhesive bonding methods that are used to secure the various auxiliary elements. Likewise, it is possible to use different injectable materials according to the intended mechanical properties of the half-shells.

Although illustrative embodiments of the invention have been shown and described, a wide range of modification, change and substitution is contemplated in the foregoing disclosure and in some instances, some features of the present invention may be employed without a corresponding use of the other features. Accordingly, it is appropriate that the appended claims be construed broadly and in a manner consistent with the scope of the invention.

What is claimed:

1. A method for manufacturing a part (4, 5) of a sports boot (1) in composite material from flat elements (21, 22), which comprises the following steps:
preparing a first blank (22) in a first flexible material intended to form the external face of the boot part, and a second blank (21) in a second flexible material intended to form the internal face of the boot part (4, 5),
placing the first and second blanks on the impression of a first half (31) of a mold (30), with the first blank (22) against the impression,
closing the mold (30) by using its second half (32),
injecting a foamable binding material between the blanks (21, 22), and
mold release after polymerization of the injected material so as to obtain the boot part (4, 5).

2. The method as claimed in claim 1, wherein the part (4, 5) of the sports boot is a part of the upper of the boot.

3. The method as claimed in claim 1, wherein the first material comprises a synthetic fabric.

4. The method as claimed in claim 1, wherein the first material comprises an elastic fabric.

5. The method as claimed in claim 1, wherein the first material is waterproofed by an elastomer.

6. The method as claimed in claim 1, wherein the first material has a thickness of from 0.8 to 1 mm.

7. The method as claimed in claim 1, wherein the second material comprises a synthetic fabric.

8. The method as claimed in claim 1, wherein the second material comprises an elastic fabric.

9. The method as claimed in claim 1, wherein the second material comprises a polyester felt.

10. The method as claimed in claim 1, wherein the injected material is a polyurethane foam.

11. The method for manufacturing a part of a sports boot (1) as claimed in claim 1, wherein at least one element (9a, 10, 11, 12, 23) is affixed to at least one of the blanks (21, 22), which is intended to form the internal or external face of the part, before it is placed in the injection mold (30).

12. The method as claimed in claim 11, wherein the affixed part is a decorative pattern (23) applied by a screen printing method.

13. The method as claimed in claim 11, wherein the affixed element is an eyelet (9a) for a lace.

14. The method as claimed in claim 11, wherein the affixed element is a ring (10) for gripping.

15. The method as claimed in claim 11, wherein the affixed element is a watertight flap (11).

16. The method as claimed in claim 11, wherein the affixed element is a protecting tongue (12).

17. The method as claimed in claim 11, wherein the affixed element is a reinforcing element.

18. The method as claimed in claim 11, wherein the affixed element is a comfort element having a density different to that of the injected foamable material.

19. The method as claimed in claim 11, wherein the affixed element is a compartment intended to hold an injected personalization material.

20. A method for manufacturing an upper (2) of a sports boot (1), wherein parts (4, 5) of an upper which have been produced as claimed in claim 1 are assembled.

21. An upper (2) of a sports boot obtained by the method as claimed in claim 20.
